(19) United States
(12) Patent Application Publication
(10) Pub. No.: US 2012/0015282 A1
(43) Pub. Date: Jan. 19, 2012

(54) SOLID OXIDE FUEL CELL

(76) Inventors: Young-Sun Kwon, Yongin-si (KR); Jun-Won Suh, Yongin-si (KR); Jan-Dee Kim, Yongin-si (KR); Ho-Jin Kweon, Yongin-si (KR)

(21) Appl. No.: 13/171,338

(22) Filed: Jun. 28, 2011

(30) Foreign Application Priority Data
Jul. 15, 2010 (KR) 10-2010-0068464

(51) Int. Cl. H01M 8/10

(52) U.S. Cl. 429/482

(57) ABSTRACT

A solid oxide fuel cell is provided. The solid oxide fuel cell has a structure in which a separate thermal expansion member is provided in a current collecting body formed on the inner circumferential surface of a first electrode so that the uniform contact between a support body of the first electrode and the current collecting body can be maintained even though the internal diameter of the support body of the first electrode is changed. Accordingly, the current collection performance of the current collecting body is enhanced through the thermal expansion member between the first electrode and the current collecting body, thereby improving the entire performance of the fuel cell.

### CROSS-REFERENCE TO RELATED APPLICATION

This application claims priority to and the benefit of Korean Patent Application No. 10-2010-0068464, filed on Jul. 15, 2010, in the Korean Intellectual Property Office, the entire content of which is incorporated herein by reference.

### BACKGROUND

1. Field

The following description relates to a solid oxide fuel cell, and more particularly, to a current collecting structure of a solid oxide fuel cell.

2. Description of the Related Art

In a solid oxide fuel cell, particularly a tubular solid oxide fuel cell, a unit cell has a structure in which an electrolytic layer and a cathode are sequentially stacked on the outer circumferential surface of an anode. A current collecting body for internal current collection of each unit cell is formed on the inner circumferential surface of the anode. In the current collecting body, a felt layer made of a metallic material is adhered closely to the inner circumferential surface of the anode. In this case, the felt layer should be entirely in uniform contact with the inner circumferential surface of the anode so that an appropriate current collecting efficiency of the fuel cell can be obtained in the driving process of the fuel cell.

In operation, the volume of the anode may be changed due to the range of the driving temperature of the solid oxide fuel cell and the property of a ceramic material forming the anode. In a case where the volume of the anode is changed as described above, the contact between the current collecting body and the inner circumferential surface of the anode may not be uniformly formed.

Therefore, contact resistance occurs between the current collecting body and the inner circumferential surface of the anode, and consequently, the driving efficiency of each cell is degraded. In a case where a current collecting member made of a metallic material is inserted into the inner surface of the current collecting body to support the current collecting body and to conduct current to the exterior of the fuel cell, the corrosion of the current collecting member may also occur. As a result, the performance of the entire current collecting body may be further degraded.

### SUMMARY

An aspect of an embodiment of the present invention is directed toward a solid oxide fuel cell in which although the volume of an anode is changed in a driving process of the fuel cell, a uniform contact between the anode and a current collecting body can be maintained, so that it is possible to prevent the current collection efficiency of the fuel cell from being lowered due to contact resistance.

An aspect of an embodiment of the present invention is directed toward a solid oxide fuel cell in which the conductivity of a current collecting body is increased by itself, so that the current collection efficiency of the fuel cell can be enhanced.

An aspect of an embodiment of the present invention is directed toward a solid oxide fuel cell in which the occurrence of corrosion of a current collecting body or a metal tube that supports the current collecting body is prevented, so that it is possible to prevent (or protect from) the degradation of current collection efficiency and to improve durability.

According to an embodiment of the present invention, there is provided a solid oxide fuel cell including a first electrode, a second electrode formed on the outer circumferential surface of the first electrode, an electrolytic layer positioned between the second and first electrodes, and a current collecting body electrically coupled to the inner circumferential surface of the first electrode, wherein the current collecting body includes a metal tube inserted into the inner circumferential surface of the first electrode, and a thermal expansion member coated on the outer circumferential surface of the metal tube.

The current collecting body may further include a felt layer formed to come in contact with the inner circumferential surface of the first electrode, and a current collecting wire layer having metal wires positioned between the felt layer and the thermal expansion member.

The thermal expansion member may be made of a thermally grown oxide (TGO).

The sum of thermal expansion coefficients of the thermal expansion member and the metal tube may be greater (or not less) than the thermal expansion coefficient of the first electrode.

The thermal expansion member may be made of a conductive material.

The thermal expansion member may be an oxide including Mn and Co elements.

The thermal expansion member may be formed using any one of application or deposition techniques.

The felt layer may be formed of Ni or stainless steel (SUS), and the density of the felt layer may be at or between 700 and 3000 kg/V.

The metal wire in the current collecting wire layer may be formed of one selected from the group consisting of Ni, stainless steel (SUS) and Ag, and the thickness of the metal wire may be at or between 0.1 and 2.0 mm.

A metal paste layer may be further provided between the current collecting wire layer and the felt layer. The metal paste layer may be formed of one or more selected from the group consisting of Ni oxide, zirconia and mixture of the Ni oxide and the zirconia. The metal paste layer may be formed of one or more selected from the group consisting of lanthanum strontium cobaltate (LSC), LaMnO₃, LaCoO₃C, Ag and Pt.

The viscosity of the metal paste layer may be at or between 150 and 250 Pa·s.

The metal tube may be formed of any one selected from the group consisting of ferritic stainless steel, austenitic stainless steel, Fe—Ni-base superalloy, Cr-base alloy and Co-base superalloy.

The metal tube may be the ferritic stainless steel, and (Mn, Co₃)O₄ may be coated on the surface of the ferritic stainless steel.

The ferritic stainless steel may be ferritic stainless steel of AISI 430 series.

As described above, according to embodiments of the present invention, although the volume of the first electrode (e.g., an anode) is increased in the driving process of a fuel cell, a uniform contact between the first electrode (the anode) and the current collecting body can be always maintained throughout the entire inner circumferential surface of the anode, so that it is possible to enhance the current collection efficiency of the fuel cell.

Also, the conductivity of a metal tube that supports the current collecting body is increased, so that it is possible to enhance the current collection efficiency of the fuel cell.

Also, the corrosion of the metal tube is prevented (or protected from) in the driving process of the fuel cell, so that it is possible to improve fuel cell durability.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a front sectional view showing a unit cell of a fuel cell including a current collecting body.

FIGS. 2 and 3 are side and front sectional views showing the stacked structure and thermal expansion structure of a unit cell of a fuel cell according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

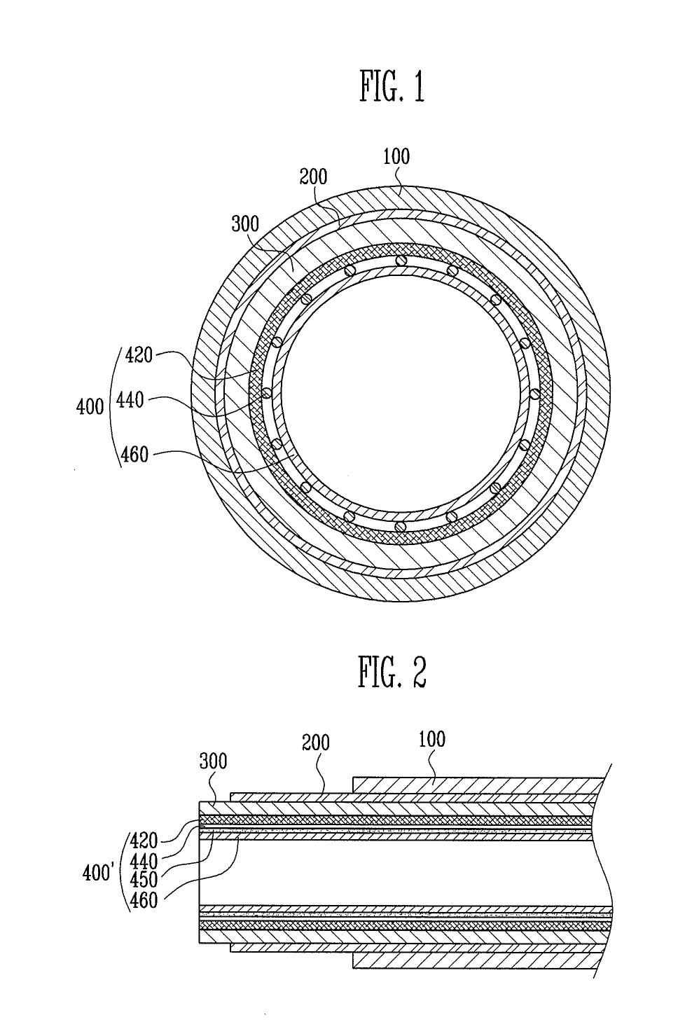

FIG. 1 shows a section of a unit cell of a tubular solid oxide fuel cell. As shown in FIG. 1, an electrolytic layer 200 and a second electrode 100 that is a cathode are sequentially stacked on the outer circumferential surface of a first electrode 300 that is an anode.

The second electrode 100 is formed of a pure electron conductor or mixed conductor such as a LaMnO₃- or LaCoO₃-based conductor, which has high ion and electron conductivity, stability under an oxygen atmosphere, and no chemical reaction with the electrolytic layer 200 which will be described later in more detail.

The electrolytic layer 200 provided to the interior of the second electrode 100 is a portion that serves as a path along which oxygen ions produced through the second electrode 100 and hydrogen ions produced through the first electrode 300 which will be described later in more detail are moved. The electrolytic layer 200 is also formed in the shape of a hollow tube, and the outer circumferential surface of the electrolytic layer 200 is adhered tightly to the entire inner circumferential surface of the second electrode 100.

The electrolytic layer 200 is made of a ceramic material having a compactness with which gas does not penetrate the ceramic material. Particularly, yttria stabilized zirconia (hereinafter, referred to as “YSZ”) obtained by adding a small amount of Y₂O₃ to ZrO₂ is used as the electrolytic layer 200. Thus, the electrolytic layer 200 is formed into a structure that has high ion conductivity under oxidation and reduction atmospheres and chemical and physical stability.

The first electrode 300 provided to the interior of the electrolytic layer 200 is a portion to which hydrogen gas that is fuel of the solid oxide fuel cell is supplied.. The anode 300 is formed in the shape of a hollow circular tube having both ends that are opened (i.e. opened ends), and the outer circumferential surface of the first electrode 300 is adhered tightly to the entire inner circumferential surface of the electrolytic layer 200.

The first electrode 300 that is an anode is basically made of a ceramic material such as YSZ. Particularly, a metal ceramic complex (cermet) such as NiO-8YSZ or Ni-8YSZ is used as the first electrode 300. Here, the metal ceramic complex (cermet) is inexpensive and stable under a high-temperature reduction atmosphere.

In addition, a current collecting body for performing internal current collection of each unit cell is formed on the inner circumferential surface of the first electrode 300. The current collecting body 400 is formed into a multiple-tube structure in which a felt layer 420 is adhered closely to the inner circumferential surface of the first electrode 300, a current collecting wire layer 440 is formed on the inner circumferential surface of the felt layer 420, and a metal tube 460 (that supports the felt layer 420 and the current collecting wire layer 440) is inserted into the interior of the current collecting wire layer 440.

The felt layer 420 is used in the conduction between the first electrode 300 and the metal tube 460. The metal tube 460 is used for collecting current and to secure a sufficient contact area (or contact force) between the current collecting body 400 and the first electrode 300. The felt layer 420 is formed from a flat plate made of a Ni material that is adhered tightly to the entire inner circumferential surface of the first electrode 300. As a result, the felt layer 420 has a circular tube shape. The felt layer 420 may be formed to come in direct contact with the inner circumferential surface of the first electrode 300. However, in another embodiment, a separate metal paste may be coated on the outer circumferential surface of the felt layer 420 for the purpose of uniform contact between the felt layer 420 and the first electrode 300 so that the felt layer 420 comes in contact with the first electrode 300 through the metal paste.

Also, the felt layer 420 necessarily comes in uniform contact with the entire inner circumferential surface of the first electrode 300 so that the appropriate current collection efficiency of the fuel cell can be obtained in the driving process of the fuel cell. If the current collecting body 400 does not come in uniform contact with the first electrode 300, the contact resistance between the current collecting body 400 and the first electrode 300 is increased, and therefore, the current collection efficiency is lowered.

However, in the case of the first electrode according to one embodiment, NiO is used as a support body, and the NiO has a property that its volume is contracted at a high driving temperature (600 to 800° C.). Since the volume of the first electrode is contracted, thermal expansion may occur in the inside diameter of the first electrode. If such thermal expansion occurs, the contact between the inner circumferential surface of the first electrode 300 and the current collecting body 400 may not be uniformly formed as the volume of the first electrode, i.e., the inside diameter of the first electrode is increased. Therefore, the contact resistance between the inner circumferential surface of the first electrode 300 and the current collecting body 400 occurs, and consequently, the driving efficiency of each cell is lowered.

The metal tube 460 of the current collecting body 400 is also thermally expanded to some degree due to the high temperature in the driving process, and therefore, the volume of the current collecting body is entirely expanded. However, since the metal tube 460 usually has a lower thermal expansion coefficient than the first electrode 300, the volume expansion coefficient of the metal tube 460 cannot keep up with that of the first electrode 300. Therefore, the contact resistance between the first electrode 300 and the current collecting body 400 may be increased.

Since a stainless steel material is used as the metal tube 460, the metal tube 460 includes a chrome element that functions to prevent (or protect from) corrosion and to maintain durability. In a case where the fuel cell is driven for a long period of time, the chrome element is volatilized at the high driving temperature of the fuel cell, and therefore, the corrosion of the metal tube 460 may occur. As a result, the corrosion of the metal tube 460 results in the degradation of the entire performance of the current collecting body.

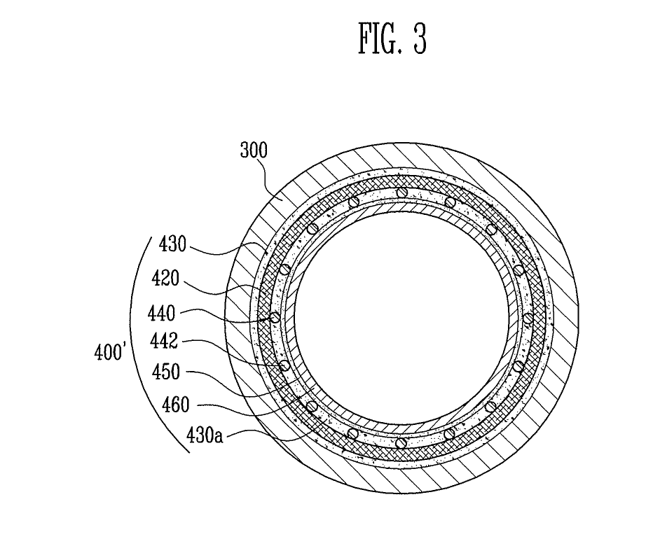

As shown in FIGS. 2 and 3, a solid oxide fuel cell according to an embodiment of the present invention includes a second electrode 100, an electrolytic layer 200, a first electrode 300 and a current collecting body 400′. The solid oxide fuel cell has a multiple-tube structure in which the electrolytic layer 200 and the second electrode 100 are sequentially stacked on the outer circumferential surface of the first electrode 300, and the current collecting body 400′ is formed on the inner circumferential surface of the first electrode 300.

Hereinafter, detailed descriptions of the second electrode 100 and the electrolytic layer 200 will not be provided again, and the first electrode 300 will be mainly described. The first electrode 300 is a portion that supplies hydrogen gas that is fuel of the fuel cell. The first electrode 300 is formed in the shape of a hollow circular tube having both ends that are opened (i.e., opened ends). The outer circumferential surface of the first electrode 300 is adhered closely to the entire inner circumferential surface of the electrolytic layer 200. As described above, a metal ceramic complex (cermet) such as NiO-8YSZ or Ni-8YSZ, which is similar to the YSZ that is the electrolytic layer 200, is used as the first electrode 300.

In addition, the current collecting body 400′ for collecting current in the interior of each unit cell is provided on the inner circumferential surface of the first electrode 300. The current collecting body 400′ is formed into a structure in which a felt layer 420, a current collecting wire layer 440 and a metal tube 460 are stacked.

The felt layer 420 is used to perform the conduction between the first electrode 300 and the metal tube 460 in the process of collecting current and to secure a sufficient contact area between the current collecting body 400′ and the first electrode 300. The felt layer 420 is adhered closely to the entire inner circumferential surface of the first electrode 300. The felt layer 420 may be made of Ni, stainless steel (SUS), or the like.

In the implementation of the current collecting body 400′ and according to one embodiment of the present invention, the density of the felt layer 420 is at or between 700 and 3000 kg/m′. In one embodiment, if the density of the felt layer 420 is less than 700 kg/m′, the current collecting efficiency of the fuel cell is lowered.

In another embodiment, if the density of the felt layer 420 exceeds 3000 kg/m′, the density is excessively high. Therefore, it is difficult to form the felt layer in a desired shape, and the felt layer may be fractured in the insertion of the felt layer into the cylindrical multiple-tube cell.

The felt layer 420 may be formed to come in direct contact with the inner circumferential surface of the first electrode 300, or a separate metal paste may be coated on the outer circumferential surface of the felt layer 420 for the purpose of uniform contact between the felt layer 420 and the first electrode 300 so that the felt layer 420 comes in contact with the first electrode 300 through a metal paste layer 430.

In one embodiment, the metal paste layer 430 is formed using Ni oxide or zirconia, or using a mixture thereof. In this embodiment, a material of the second electrode 100 such as lanthanum strontium cobaltate (LSC), LaMnO₃ or LaCoO₃ may be used as the metal paste layer 430. Preferably, LSC may be used as the metal paste layer 430. The metal paste layer 430 may also be formed using a precious metal such as Ag or Pt.

In one embodiment, the viscosity of the metal paste layer 430 is at or between 150 and 250 Pa·s. In one embodiment, if the viscosity of the metal paste layer 430 is less than 150 Pa·s, the felt layer 420 runs down due to its wateriness, and therefore, the adhesive performance of the felt layer 420 is not properly performed. In another embodiment, if the viscosity of the metal paste layer 430 exceeds 250 Pa·s, the movement of fuel such as hydrogen is difficult, and consequently, the current collection efficiency of the fuel cell is lowered.

In addition, the current collecting wire layer 440 provided to the felt layer 420 is used to support the felt layer 420 and to perform stable connection between the felt layer 420 and the metal tube 460 (which will be described later in more detail). The current collecting wire layer 440 is formed into a structure in which metal wires 442 are fixedly formed at an interval around the inner circumferential surface of the felt layer 420. In this embodiment, the current collecting wire layer 440 refers to the entire inner surface formed by allowing the metal wire 442 to be adhered closely to the inner circumferential surface of the felt layer 420, and the metal wire 442 refers to only a portion that functions to collect current in the current collecting wire layer 440. In the following description, the current collecting wire layer 440 and the metal wire 442 included in the current collecting wire layer 440 will be described in more detail and clarified from each other.

Each of the metal wire 442 provided to the current collecting wire layer 440 may be selectively made of Ag, Ni, SUS, or the like, according to the material of the felt layer 420. In one embodiment, the metal wire 442 is formed to have a thickness of 0.1 to 2.0 mm in view of strength and conductivity. In one embodiment, if the metal wire 442 is too thick, it is difficult to weld the metal wire 442 to the felt layer 420. In another embodiment, if the thickness of the metal wire 442 is less than 0.1, it is difficult to collect current.

A metal paste layer 430a may be formed between the respective metal wires 442 so that it is possible to sufficiently ensure the fixation of each of the metal wires 442 and the contact area between the current collecting wire layer 440 and the felt layer 420.

A metal tube 460 is formed to be inserted into the interior of the current collecting wire layer 440. Here, the metal tube 460 serves as a path along which hydrogen gas moves, and functions to support the felt layer 420 and the current collecting wire layer 440.

In one embodiment, the metal tube 460 is made of SUS, and is formed so that the entire outer circumferential surface of the metal tube 460 comes in contact with the entire inner circumferential surface of the current collecting wire layer 440.

The material of the metal tube 460 is not limited to any one material but may be variously changed depending on materials of the felt layer 420 and the current collecting wire layer 440. In this embodiment, the material of the metal tube may include any one selected from the group consisting of ferritic stainless steel, austenitic stainless steel, Fe—Ni-base superalloy, Cr-base alloy and Co-base superalloy.

Particularly, among the above list materials, the ferritic stainless steel of the AISI 430 series has superior corrosion resistance and economical efficiency. Therefore, the ferritic stainless steel of the AISI 430 series may be used as the material of the metal tube 460.

In this instance, a thermal expansion member 450 may be formed between the metal tube 460 and the current collecting wire layer 440, i.e., on the outer circumferential surface of the metal tube 460. The thermal expansion member 450 is a component additionally provided so that a uniform contact with the first electrode 300 can be maintained by enhancing the volume growth rate of the entire current collecting body 400′ in the driving process of the fuel cell.

The thermal expansion member 450 may be made of a thermally grown oxide (hereinafter, referred to as ‘TGO’) such as Mn or Co₃, which is a material that can be coated on the outer circumferential surface of stainless steel applicable to this embodiment. Here, the TGO has a property that it is thermally expanded at the driving temperature of the fuel cell, and therefore, its volume is increased.

As a material having conductivity in itself is used as the material that constitutes the thermal expansion member 450, the thermal expansion member 450 has no detrimental influence on the current collection efficiency of the fuel cell even though it is coated on the metal tube 460. On the contrary, as the volume of the thermal expansion member 450 is increased itself, the entire conductivity of the metal tube 460 can be enhanced.

For reference, the material of the thermal expansion member 450 applied to this embodiment is not limited to the two kinds of mentioned materials, but any TGO-based material may be selectively applied.

The thermal expansion member 450 may be coated on the outer circumferential surface of the metal tube 460 through an application technique, a deposition technique or the like.

As the thermal expansion member 450 is provided as described above, the metal tube 460 and the current collecting wire layer 440 do not come in direct contact with each other but come in indirect contact with each other via the medium of the thermal expansion member 450.

Hereinafter, the operation and effect of the embodiment of the present invention will be described in more detail.

First, as the fuel cell is driven at a temperature of 600 to 1000° C. in the state that the current collecting body 400′ including the thermal expansion member 450 is installed in the first electrode 300 as shown in FIGS. 2 and 3, the first electrode 300 made of a ceramic material is thermally expanded, and therefore, the internal and external diameters of the first electrode 300 is increased.

In this process, the metal tube 460 of the current collecting body 400′ is thermally expanded together with the first electrode 300, so that the unequal contact between the current collecting body 400′ and the first electrode 300 due to a change in the volume of the first electrode 300 can be prevented to some degree. However, since the thermal expansion coefficient of the first electrode 300 is greater than that of the metal tube 460 as described above, contact resistance occurs due to the unequal contact between the felt layer 420 and the first electrode 300 in a related art.

However, in this embodiment, the thermal expansion member 450 is thermally expanded at the same time together with an increase in the volume of the metal tube 460, and accordingly, the rate of increase in the diameter of the current collecting wire layer and the felt layer 420 is also increased as compared with the related art.

That is, as the sum of the thermal expansion coefficients of the metal tube 460 and the thermal expansion member 450 is greater (or not less) than that of the first electrode 300, the volume growth rate of the entire current collecting body 400′ is increased as compared with the related art.

As such, the volume of the current collecting body 400′ is increased as much as the volume growth rate of the first electrode 300 through the thermal expansion member 450. Accordingly, although the volume of the first electrode 300 is increased, the uniform contact between the felt layer 420 and the inner circumferential surface of the first electrode 300 is maintained, so that it is possible to prevent (or protect from) the increase in contact resistance between the felt layer and the first electrode, which occurs in the related art.

Thus, unlike the related art, it is possible to prevent (or protect) internal current collection efficiency from being lowered due to the contact resistance.

As described above, the thermal expansion member 450 has conductivity in addition to the thermal expansion property. Hence, in a case where the volume of thermal expansion member 450 is increased in the state that the thermal expansion member 450 is coated on the metal tube 460, the conductivity between the metal tube 460 and the current collecting wire layer 440 is also increased. Thus, the entire current collection efficiency of the fuel cell can be enhanced as compared with the related art.

As the fuel cell is driven in the state that the thermal expansion member 450 is coated on the metal tube 460, the thermal expansion member 450 serves as a cover that prevents the volatilization of a chrome element contained in the metal tube 460 in the driving process of the fuel cell. Since the thermal expansion member 450 prevents the volatilization of the chrome element, it is possible to prevent the corrosion and deterioration of the metal tube 460, so that the durability of the metal tube 460 can be improved. Accordingly, the entire lifespan (or lifetime) of the current collecting body can be increased.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A solid oxide fuel cell comprising:
a first electrode;
a second electrode on the outer circumferential surface of the first electrode;
an electrolytic layer between the second electrode and the first electrode; and
a current collecting body electrically coupled to the inner circumferential surface of the first electrode,
wherein the current collecting body comprises a metal tube inserted into the inner circumferential surface of the first electrode, and a thermal expansion member coated on the outer circumferential surface of the metal tube.

2. The solid oxide fuel cell according to claim 1, wherein the thermal expansion member comprises Mn and Co elements.

3. The solid oxide fuel cell according to claim 1, wherein the current collecting body further comprises a felt layer in contact with the inner circumferential surface of the first electrode, and a current collecting wire layer having metal wires positioned between the felt layer and the thermal expansion member.

4. The solid oxide fuel cell according to claim 3, wherein the thermal expansion member comprises Mn and Co elements.

5. The solid oxide fuel cell according to claim 3, wherein the thermal expansion member is composed of a thermally grown oxide (TGO).

6. The solid oxide fuel cell according to claim 5, wherein the thermal expansion member comprises Mn and Co elements.

7. The solid oxide fuel cell according to claim 3, wherein the sum of thermal expansion coefficients of the thermal expansion member and the metal tube is greater than the thermal expansion coefficient of the first electrode.

8. The solid oxide fuel cell according to claim 7, wherein the thermal expansion member comprises Mn and Co elements.

9. The solid oxide fuel cell according to claim 7, wherein the thermal expansion member is composed of a conductive material.

10. The solid oxide fuel cell according to claim 9, wherein the thermal expansion member comprises Mn and Co elements.

11. The solid oxide fuel cell according to claim 3, wherein the density of the felt layer is at or between 700 and 3000 kg/m′.

12. The solid oxide fuel cell according to claim 3, wherein each of the metal wires in the current collecting wire layer comprises Ni, stainless steel (SUS), and/or Ag.

13. The solid oxide fuel cell according to claim 13, wherein each of the metal wires has a thickness of at or between 0.1 and 2.0 mm.

14. The solid oxide fuel cell according to claim 3, wherein a metal paste layer is further provided between the current collecting wire layer and the felt layer.

15. The solid oxide fuel cell according to claim 14, wherein the metal paste layer comprises Ni oxide and/or zirconia.

16. The solid oxide fuel cell according to claim 14, wherein the metal paste layer comprises lanthanum strontium cobaltate (LSC), LaMnO₃, LaCoO₃C, Ag and/or Pt.

17. The solid oxide fuel cell according to claim 3, wherein the metal tube comprises ferritic stainless steel, austenitic stainless steel, Fe—Ni-base superalloy, Cr-base alloy and/or Co-base superalloy.

18. The solid oxide fuel cell according to claim 17, wherein the metal tube is the ferritic stainless steel, and (Mn, Co₃)O₄ is coated on the surface of the ferritic stainless steel.

19. A solid oxide fuel cell comprising:
a first electrode;
a second electrode;
an electrolytic layer between the second electrode and the first electrode; and
a current collecting body electrically coupled to the inner circumferential surface of the first electrode,
wherein the current collecting body comprises a metal tube provided into the inner circumferential surface of the first electrode, and a thermal expansion member coated on the outer circumferential surface of the metal tube.

20. The solid oxide fuel cell according to claim 19, wherein the current collecting body further comprises a felt layer in contact with the inner circumferential surface of the first electrode, and a current collecting wire layer having metal wires positioned between the felt layer and the thermal expansion member, and wherein the sum of thermal expansion coefficients of the thermal expansion member and the metal tube is not less than the thermal expansion coefficient of the first electrode.
